(19) United States
(12) Patent Application Publication
(10) Pub. No.: US 2003/0137699 A1
(43) Pub. Date: Jul. 24, 2003

(54) Method of changing halftone dot area, and device and program for processing halftone data

(75) Inventors: Makoto Narazaki, Kyoto (JP); Osamu Kitagawa, Kyoto (JP)

Correspondence Address: MCDERMOTT, WILL & EMERY, 600 13th Street, N.W., Washington, DC, 20005-3096, US

(73) Assignee: DAINIPPON SCREEN MFG. CO., LTD.

(21) Appl. No.: 10/339,326

(22) Filed: Jan. 10, 2003

(30) Foreign Application Priority Data
Jan. 24, 2002 (JP) P2002-015493

(51) Int. Cl. G06K 15/00; H04N 1/40

(52) U.S. Cl. 358/3.06; 358/3.05

(57) ABSTRACT

A method of changing a halftone dot area is provided. The method includes: performing an expansion process on rasterized binary halftone image data to generate multi-level halftone image data; processing the expanded halftone image data using an averaging mask to convert the expanded halftone image data into multi-level halftone image data having intermediate gradation levels; performing a gradation conversion on the multi-level halftone image data having the intermediate gradation levels based on a predetermined tone curve to perform a spreading/shrinking process for changing a density in an edge portion of a halftone dot; and performing an error diffusion process based on the corrected gradation to represent gradation in the form of small dots having densities corresponding to original gradation levels, thereby generating halftone data for proof in which the halftone dot area is changed in accordance with the output characteristic of an output device.

### BACKGROUND OF THE INVENTION

1. Field of the Invention

The present invention relates to a method of changing an area rate or a spot size of a halftone dot in binary halftone image data, and a device and a program for processing the binary halftone image data.

2. Description of the Background Art

Recent prepress operation includes rasterizing digital image data about a print to convert the digital image data into binary image data, and then outputting the binary image data to an output device in a following stage, such as a CTP (computer-to-plate) device and an image setter. The rasterization performs a screening process on a picture to generate binary halftone image data.

It is known that a general printed material exhibits a so-called “dot gain” phenomenon in which halftone dots become larger because ink spreads out. To prevent this phenomenon, it is a customary practice in the prepress operation to previously correct halftone (or a halftone dot area) in image data in accordance with the characteristics of a printing machine and a printing paper to be used. In other words, the rasterization process has been performed so that the halftone is corrected during the screening process. The “correction of halftone” which is achieved by changing the area rate of each halftone dot is equivalent to the “correction of a halftone dot area rate.”

With the computerization of the prepress operation, an output process using digital image data has been carried out in a conventional color proof operation. Specifically, proofed prints are provided using image data for actual use in the prepress operation, for example, by means of an ink jet printer in a simplified manner.

There is, however, a difference in dot gain characteristics between an output device for use in color proof such as an ink jet printer and a typical printing machine. Further, an ink jet printer exhibits different dot gain characteristics, depending on the conditions of printing paper to be used, and the like. In such a case, if the same binary halftone image data is used, there arises a difference in tint between proofed prints produced by respective output devices, which is undesirable. Thus, precise color proof requires binary halftone image data in which halftone is corrected for color proof, aside from the binary halftone image data for use in prepress operation.

Unfortunately, the production of the binary halftone image data by the rasterization process is a relatively heavy operation, and the execution of the rasterization process for production of the binary halftone image data for color proof leads to the increase in time required for operation. The color proof operation is also capable of correcting conversion errors caused during the rasterization process, and the like. However, if another rasterization process is performed for color proof, it is impossible to make substantial correction to rasterization conversion errors caused during the production of the binary halftone image data for use in actual prepress operation.

A contractor who undertakes printing of magazine advertisements and the like is sometimes supplied with screened documents or rasterized halftone image data from his/her client. In this case, since he/she is given no digital image data, the contractor cannot perform a new screening process to make the halftone correction itself.

### SUMMARY OF THE INVENTION

The present invention is intended for a method of changing the area rate of each halftone dot.

According to the present invention, the method of changing the area rate of each halftone dot comprises the steps of: a) expanding binary halftone data defining first halftone dots to multi-level halftone data; b) replacing a gradation level of each pixel of the multi-level halftone data with an average gradation level based on gradation levels of an objective pixel and its surrounding pixels to generate average halftone data; c) correcting gradation levels in the average halftone data in accordance with a predetermined halftone characteristic parameter to generate corrected halftone data; and d) performing a predetermined error diffusion process on the corrected halftone data to generate second halftone data representative of second halftone dots having area rates different from the first halftone dots.

The method can generate the new halftone image data in which the area of each halftone dot is changed from that in the binarized halftone image data without performing a rasterization process and the like again. This provides the halftone image data for proof in accordance with the output characteristic of an output device for proof from the already binarized halftone image data for prepress and printing.

It is therefore an object of the present invention to provide a method of changing the area rate of each halftone dot, which generates halftone image data having corrected halftone (or halftone dot area) based on rasterized binary halftone image data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart showing a procedure for changing a halftone dot area rate according to the present invention;

FIGS. 2A and 2B illustrate an expansion process;

FIGS. 3A, 3B and 3C illustrate an averaging mask process;

FIGS. 4A, 4B, 4C, 4D, 4E and 4F illustrate a halftone correction process;

FIGS. 5A and 5B illustrate examples of halftone dots subjected to an error diffusion process;

FIG. 6 is a block diagram of a halftone data processor as an example of a processor for implementing the process of changing a halftone dot area rate; and

FIG. 7 illustrates a relationship between elements implemented in a control section and data generated in the processes executed in the respective elements.

### DESCRIPTION OF THE PREFERRED EMBODIMENT

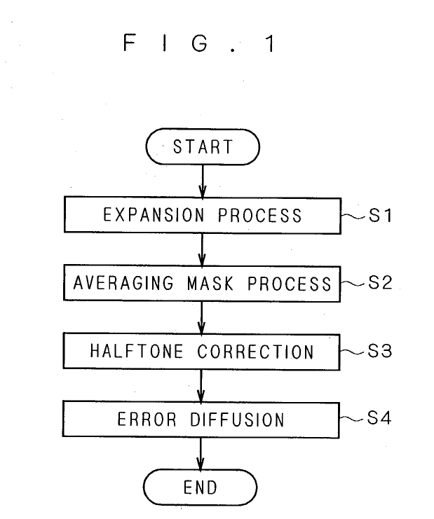

A preferred embodiment according to the present invention will now be described with reference to the drawings. A device for implementing the preferred embodiment will be described later. FIG. 1 is a flowchart showing a procedure of a halftone dot area rate changing method according to the present invention.

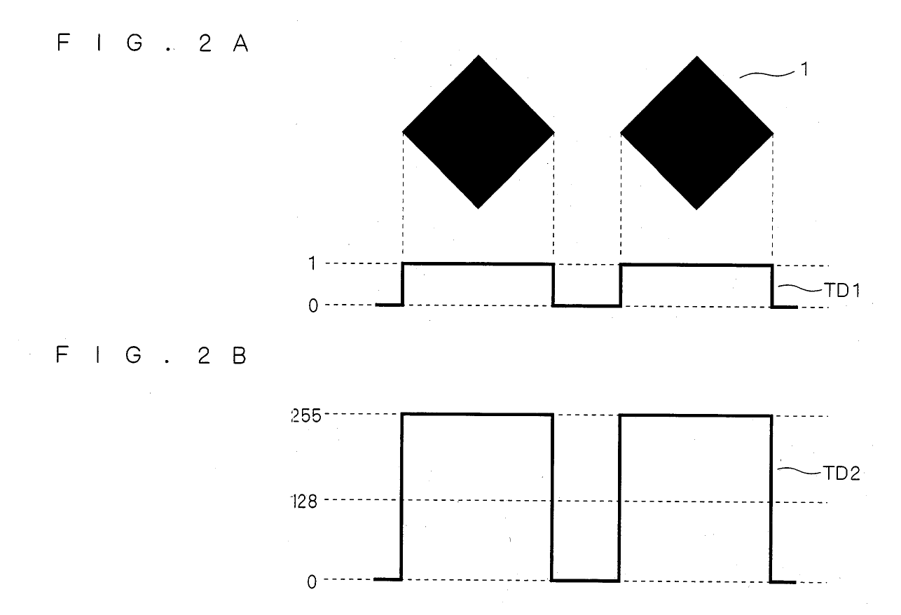

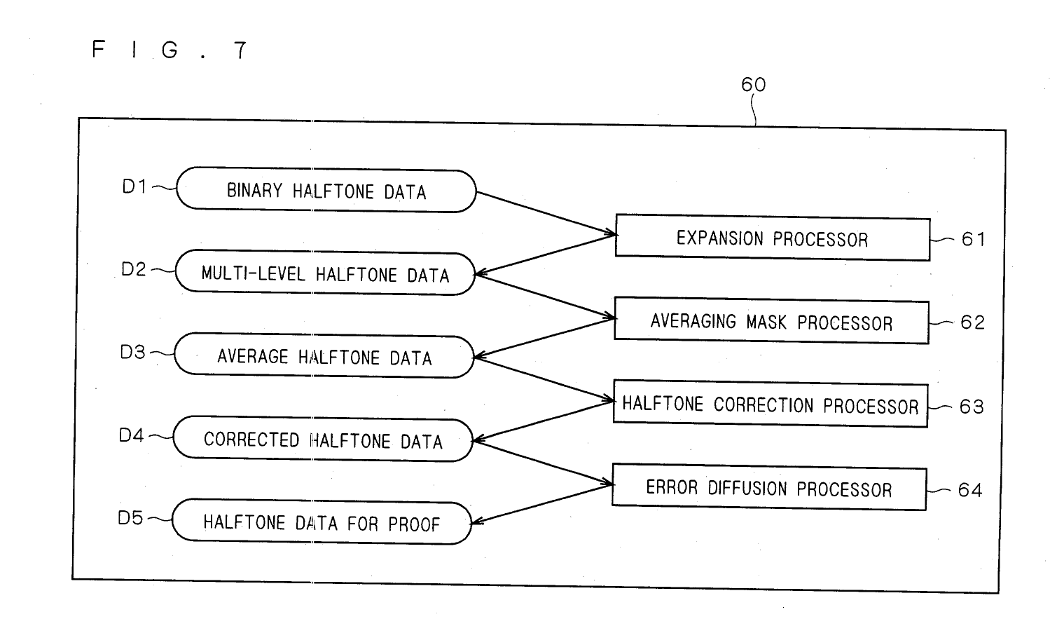

Referring to FIG. 1, an expansion process is initially performed in Step S1 in which the data length of binary halftone data D1 (FIG. 7), which is represented in binary form, is expanded to multi-level halftone data D2 (FIG. 7) having three or more multi-levels of gradation. FIGS. 2A and 2B illustrate the expansion process. FIG. 2A shows a halftone dot 1 comprised of a plurality of pixels, and a gradation distribution TD1 in a central portion of the halftone dot 1. A portion forming the halftone dot 1 has a gradation level “1” because of the presence of pixels, and the remaining portion has a gradation level “0.” The expansion process in Step S1 changes the gradation level “1” to “255” as shown in FIG. 2B to convert the gradation distribution TD1 into a gradation distribution TD2 capable of providing multi-levels of gradation. The gradation level “255” is given as an example, and the gradation level after the change need not be limited to “255.”

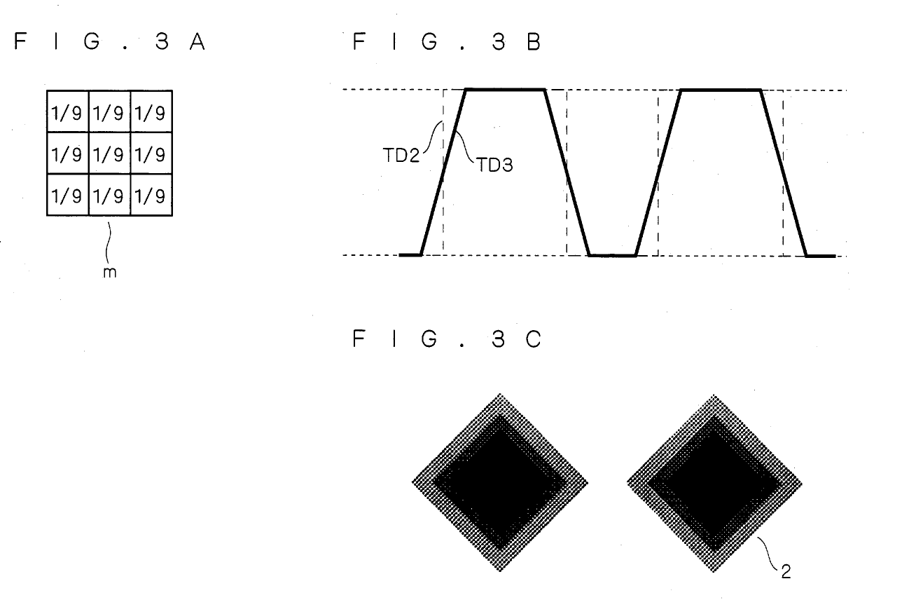

In Step S2 shown in FIG. 1, the expanded multi-level halftone data D2 is processed using a predetermined mask. A mask m having, for example, 3 by 3 pixels as shown in FIG. 3A is used in this preferred embodiment.

The mask m shown in FIG. 3A is an operator for replacing the gradation level of a pixel of interest which is one of the pixels constituting a halftone dot with the sum of 1/9 times the gradation levels of nine pixels including the objective pixel. In other words, the mask m provides the average of the gradation levels of the nine pixels including the objective pixel. Another mask may be used in place of the mask m illustrated.

Processing the gradation levels of the pixels using the mask m converts the gradation distribution TD2 in the central portion of the halftone dot 1 into, for example, a gradation distribution TD3. Specifically, this conversion is made so that an edge portion has one or more intermediate gradation levels between “0” and “255.” FIG. 3C schematically illustrates a halftone dot 2 with a blurred edge portion as an example, which corresponds to average halftone data D3 (FIG. 7) thus obtained.

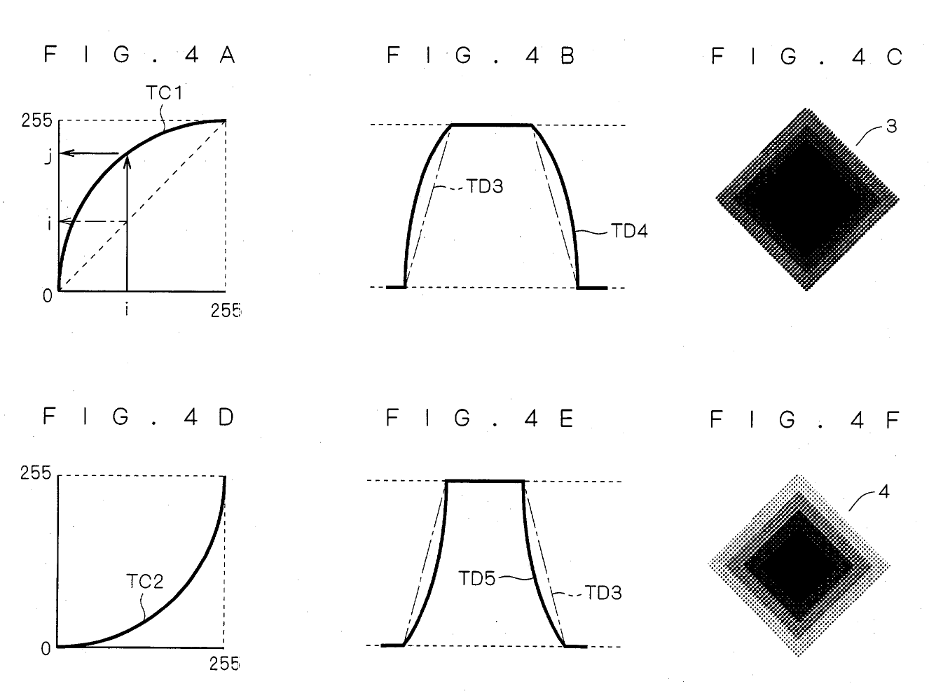

In Step S3 shown in FIG. 1, a preset halftone correction parameter is used to correct the gradation level of each pixel in the average halftone data D3 to provide corrected halftone data D4 (FIG. 7). An example of the halftone correction will be described wherein a tone curve TC1 shown in FIG. 4A is used as the halftone correction parameter. The tone curve or tone correction curve TC1 corresponds to a conversion curve for converting a gradation level before correction (on the horizontal axis) into a corrected gradation level (on the vertical axis). For example, a gradation level i before correction is converted into a gradation level j. Correcting the gradation distribution TD3 shown in FIG. 3B using a halftone characteristic based on the tone curve TC1 provides a gradation distribution TD4 shown in FIG. 4B. This correction is a spreading process performed on the halftone dot whereby the edge portion of the halftone dot has an enhanced density. FIG. 4C schematically illustrates a halftone dot 3 subjected to the spreading process as an example.

Likewise, making the halftone correction using a tone curve TC2 shown in FIG. 4D as a halftone correction parameter provides a corrected gradation distribution TD5 shown in FIG. 4E. This correction is a shrinking process performed on the halftone dot whereby the edge portion of the halftone dot has a lowered density. FIG. 4F schematically illustrates a halftone dot 4 subjected to the shrinking process as an example.

A plurality of different halftone correction parameters such as the tone curves TC1 and TC2 are prepared in corresponding relation to the different amounts of change of the halftone dot area rates (e.g., the percentages by which the halftone dot is spread or shrunk), and previously held in a storage means such as a memory so as to be selectively used. This enables an operator who processes the halftone dot area rate to specify only the amount of change of the halftone dot area rate without concern for tone curve settings.

When the amount of change (or the amount of spreading/shrinking) of the halftone dot area rate is increased, the pixel size of the mask m may be changed at the same time. For example, changing the pixel size of the averaging mask m to 5 by 5 pixels and the like further increases the amount of change of the halftone dot area rate. In general, it is desirable that a plurality of different settings of the amount of change of the halftone dot area rate are prepared in accordance with the resolution and the number of screen lines of images and are selectable.

In Step S4 shown in FIG. 1, an error diffusion process is performed on the multi-level halftone image data subjected to the halftone correction. The error diffusion process is a typical process for generating halftone image data in ink jet printers and the like which provide an output in the form of dots. This technique is such that, if a pixel having a certain gradation level i (i=1 to 255) is not outputted, the gradation level i is taken as a difference and distributed to the gradation levels of the surrounding pixels (or the value (255−i) may be taken as a difference and distributed to the gradation levels of the surrounding pixels if the corresponding dot is outputted).

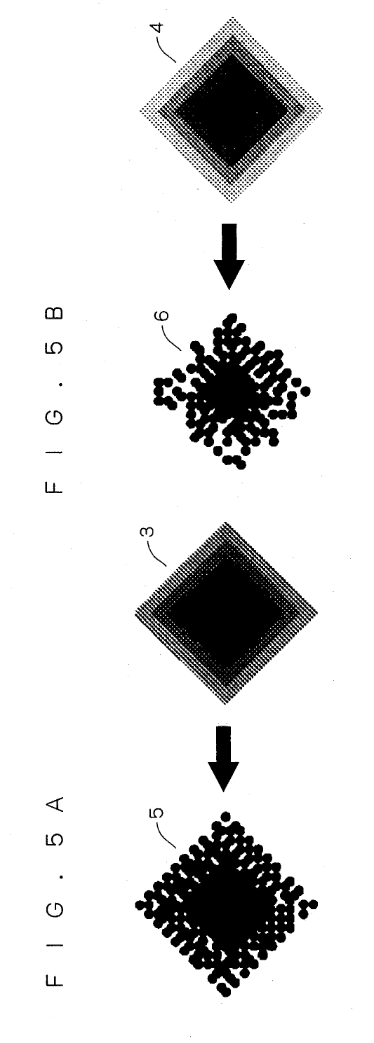

The error diffusion process binarizes the halftone dot having the multi-levels of gradation to represent the halftone image in the form of distribution of small dots having densities corresponding to original gradation levels. For example, the error diffusion process is performed on the corrected halftone data D4 to provide halftone data D5 for proof (FIG. 7), whereby halftone dots 5 and 6 with their edge portions represented by distributed small dots as schematically illustrated in FIGS. 5A and 5B are obtained from the halftone dots 3 and 4 shown in FIGS. 4C and 4F.

Thus, the present invention can produce the new halftone image data in which the halftone dot area rate is changed from that in the binarized halftone image data without performing the rasterization process and the like again. This provides the halftone image data for proof in accordance with the output characteristics of an output device for proof from the already binarized halftone image data for prepress and printing.

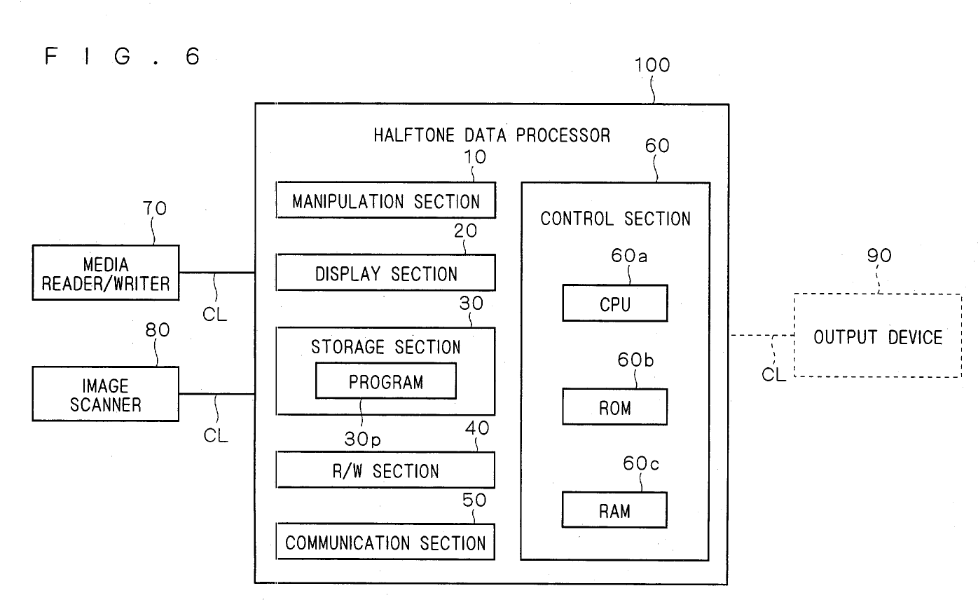

A halftone data processor 100 will be described as an example of the processor for implementing the above-mentioned process of changing the halftone dot area rate. FIG. 6 is a schematic diagram of the halftone data processor 100 and other devices connected thereto.

The halftone data processor 100 is embodied by a computer, e.g. a general-purpose personal computer. The halftone data processor 100 mainly comprises: a manipulation section 10 including a mouse and a keyboard for an operator to enter various instructions; a display section 20 such as a visual display device; a storage section 30 constructed by a hard disk and the like, and for storing a program 30p for causing the computer to function as the halftone data processor 100, and data required to process the halftone correction parameters; a R/W section 40 for reading/writing data from/to various portable recording media through a media reader/writer 70; a communication section 50 serving as an interface for transferring data to and from devices in a network not shown connected through signal lines CL; and a control section 60 including a CPU 60a,a ROM 60b and a RAM 60c and implementing functions to be described later.

In a preferable form of the halftone data processor 100, a so-called GUI (Graphical User Interface) capable of performing processes while displaying on the display section 20 operator's manipulations through the manipulation section 10 and the states of various processing is implemented by the functions of the control section 60, the manipulation section 10 and the display section 20. Preferably, the GUI is also used to perform processing in respective elements to be described later which are implemented in the control section 60.

The halftone data processor 100 is connected to the media reader/writer 70 and an image scanner 80 both serving as a data input element for inputting to the halftone data processor 100 the binary halftone data D1 and the like to be processed in the halftone data processor 100.

The media reader/writer 70 is provided to read the binary halftone data D1 and the like from various portable recording media such as an MO (magneto-optic disk) and a CD-R/RW, and to write the halftone data D5 for proof to the recording media. The media reader/writer 70 includes, for example, an MO drive and a CD-R/RW drive.

The image scanner 80 is provided to read a halftone image of a prepress film with halftone dots formed thereon. The read halftone image is stored as the binary halftone data D1 by the halftone data processor 100, and is subjected to subsequent processes.

An output device 90 provides an output for proof, based on the halftone data D5 for proof after the halftone correction which is received from the halftone data processor 100. A preferred example of the output device 90 is an ink jet printer. The transfer of the halftone data D5 for proof between the halftone data processor 100 and the output device 90 may be carried out directly through a signal line CL. Alternatively, the output device 90 capable of reading data stored in a predetermined recording medium may read from the recording medium the halftone data D5 for proof recorded temporarily on the predetermined recording medium in the halftone data processor 100.

Reading of the binary halftone data D1 into the halftone data processor 100 and sending of the halftone data D5 for proof from the halftone data processor 100 to the output device 90 may be performed via a network not shown.

FIG. 7 illustrates a relationship between elements (or processors) implemented in the control section 60 of the halftone data processor 100 and the various data generated in the above-mentioned processes executed in the respective elements.

In the control section 60, the execution of the predetermined program 30p stored in the storage section 30 implements an expansion processor 61, an averaging mask processor 62, a halftone correction processor 63, and an error diffusion processor 64 by the action of the CPU 60a, the ROM 60b and the RAM 60c.

The expansion processor 61 is responsible for the process in Step S1 of FIG. 1, that is, performing the expansion process on the binary halftone data D1 to generate the multi-level halftone data D2. The averaging mask processor 62 is responsible for the process in Step S2, that is, performing the averaging mask process on the multi-level halftone data D2 to generate the average halftone data D3. The halftone correction processor 63 is responsible for the process in Step S3, that is, performing the halftone correction process on the average halftone data D3 to generate the corrected halftone data D4. The error diffusion processor 64 is responsible for the process in Step S4, that is, performing the error diffusion process on the corrected halftone data D4 to generate the halftone data D5 for proof.

These elements (or processors) sequentially execute the respective processes shown in FIG. 1, whereby the halftone data processor 100 generate the halftone data D5 for proof in accordance with the output characteristics of the output device 90. The output device 90 performs an output process based on the halftone data D5 for proof to output prints for proof similar to original prints.

Although only the halftone image data is described in the preferred embodiment, the present invention is applicable to image data including linework. Further, the present invention is applicable to other output devices for recording images in the form of dots than an ink jet printer.

While the invention has been described in detail, the foregoing description is in all aspects illustrative and not restrictive. It is understood that numerous other modifications and variations can be devised without departing from the scope of the invention.

What is claimed is:

1. A method of changing the area rate of each halftone dot, said method comprising the steps of:
a) expanding binary first halftone data defining first halftone dots to multi-level halftone data;
b) replacing a gradation level of each pixel of said multi-level halftone data with an average gradation level based on gradation levels of an objective pixel and its surrounding pixels to generate average halftone data;
c) correcting gradation levels in said average halftone data in accordance with a predetermined halftone characteristic parameter to generate corrected halftone data; and
d) performing a predetermined error diffusion process on said corrected halftone data to generate second halftone data representative of second halftone dots having area rates different from said first halftone dots.

2. The method according to claim 1, wherein
said step b) is performed using a predetermined averaging mask.

3. The method according to claim 2, wherein
said predetermined averaging mask is one of a plurality of averaging masks having different ranges of said surrounding pixels, and
said step b) includes, the step of selecting one averaging mask among said plurality of averaging masks.

4. The method according to claim 3, wherein
said halftone characteristic parameter is a conversion curve representing a relationship between gradation levels before and after halftone correction.

5. The method according to claim 4, wherein
said halftone characteristic parameter is one of a plurality of halftone characteristic parameters, and
said step c) includes the step of selecting one halftone characteristic parameter among said plurality of halftone characteristic parameters.

6. A halftone data processor comprising:
a) an expansion element for expanding binary first halftone data defining first halftone dots to multi-level halftone data;
b) an averaging element for replacing a gradation level of each pixel of said multi-level halftone data with an average gradation level based on gradation levels of an objective pixel and its surrounding pixels to generate average halftone data;
c) a halftone correction element for correcting gradation levels in said average halftone data in accordance with a predetermined halftone characteristic parameter to generate corrected halftone data; and
d) an error diftusion element for performing a predetermined error diffusion process on said corrected halftone data to generate second halftone data representative of second halftone dots having area rates different from said first halftone dots.

7. The halftone data processor according to claim 6, wherein
said averaging element generates said average halftone data by using a predetermined averaging mask.

8. The halftone data processor according to claim 7, wherein
said predetermined averaging mask is one of a plurality of averaging masks having different ranges of said surrounding pixels, and
said averaging element includes a selection element for selecting one averaging mask among said plurality of averaging masks.

9. The halftone data processor according to claim 8, wherein
said halftone characteristic parameter is a conversion curve representing a relationship between gradation levels before and after halftone correction.

10. The halftone data processor according to claim 9, wherein
said halftone characteristic parameter is one of a plurality of halftone characteristic parameters, and
said halftone correction element includes a halftone characteristic setting element for selecting one halftone characteristic parameter among said plurality of halftone characteristic parameters.

11. The halftone data processor according to claim 10 wherein
said first halftone data is read from an input element connected to said halftone data processor.

12. The halftone data processor according to claim 11, wherein
a reading element connected to said halftone data processor reads a halftone image, whereby said first halftone data is generated.

13. A program executed by a computer to cause said computer to function as a halftone data processor comprising:
a) an expansion element for expanding first halftone data in binary form to multi-level halftone data;
b) an averaging element for replacing the gradation level of each pixel of said multi-level halftone data with an average gradation level based on the gradation levels of a pixel of interest and its surrounding pixels to generate average halftone data;
c) a halftone correction element for correcting gradation levels in said average halftone data in accordance with a predetermined halftone characteristic parameter to generate corrected halftone data; and
d) an error diffusion element for performing a predetermined error diffusion process on said corrected halftone data to generate second halftone data.
